(19) United States
(12) Patent Application Publication
(10) Pub. No.: US 2026/0307643 A1
(43) Pub. Date: Oct. 8, 2026

(54) CONTROLLING A HYBRID POWERTRAIN SYSTEM OF A VEHICLE

(71) Applicant: JAGUAR LAND ROVER LIMITED, Whitley, Coventry, Warwickshire (GB)

(72) Inventors: Daniel VAQUERIZO SANCHEZ, Whitley, Coventry, Warwickshire (GB); William HARRISON, Whitley, Coventry, Warwickshire (GB); Anders GREGERSEN, Whitley, Coventry, Warwickshire (GB)

(21) Appl. No.: 19/483,135

(22) PCT Filed: May 9, 2024
(86) PCT No.: PCT/EP2024/062859

§ 371 Date: Nov. 10, 2025

(30) Foreign Application Priority Data
May 11, 2023 (GB) 2306974.3

(51) Int. Cl. B60W 20/10; B60W 10/06; B60W 10/08; B60W 50/00

(52) U.S. Cl. CPC B60W 20/10; B60W 10/06; B60W 10/08; B60W 2050/0011; B60W 2050/0026; B60W 2510/0638; B60W 2510/081; B60W 2710/0661; B60W 2710/082

(57) ABSTRACT

A hybrid powertrain system is operable in a plurality of powertrain operating modes each having an associated set of powertrain control parameter values. The hybrid powertrain system includes an engine and an electric traction motor. The control system includes one or more controllers collectively configured to determine that the hybrid powertrain system is simultaneously operating in two or more of the plurality of powertrain operating modes; determine, based on a predetermined prioritisation index of the plurality of powertrain operating modes, which of the two or more simultaneously operating powertrain operating modes has a highest priority; and control at least one of the engine and electric traction motor via the one or more controllers based on the set of powertrain control parameter values associated with the highest priority powertrain operating mode.

### TECHNICAL FIELD

The present disclosure relates to controlling a hybrid powertrain system of a vehicle. Aspects of the invention relate to a control system, to a system, to a vehicle and to a method.

### BACKGROUND

It is known for vehicles to be powered by an internal combustion engine and one or more electric traction motors (also referred to as electric motors (EM)). Such hybrid powertrain systems may operate in different modes at different times depending on the environment and needs of the driver of the vehicle. However, management of these different modes may be problematic.

It is an aim of the present invention to address one or more of the disadvantages associated with the prior art.

### SUMMARY OF THE INVENTION

Aspects and embodiments of the invention provide a control system for controlling a hybrid powertrain system of a vehicle, a system comprising the control system and a hybrid powertrain system of a vehicle, a vehicle and a method for controlling a hybrid powertrain system of a vehicle, as claimed in the appended claims.

According to an aspect of the present invention there is provided a control system for controlling a powertrain system of a vehicle. The powertrain system is operable in a plurality of powertrain operating modes each having an associated set of powertrain control parameter values. The powertrain system comprises a plurality of prime movers, for example an engine (an internal combustion engine which may be powered by petrol, diesel or hydrogen, for example) and one or more electric traction motors (EM), or two or more engines or two or more electric traction motors. The control system comprises one or more controllers which are collectively configured to: (i) determine that the powertrain system is simultaneously operating in two or more of the plurality of powertrain operating modes; and (ii) determine, based on a predetermined prioritisation index of the plurality of powertrain operating modes, which of the two or more simultaneously operating powertrain operating modes has a highest priority. The one or more controllers may be further collectively configured to control at least one of the prime movers via the one or more controllers based on the set of powertrain control parameter values associated with the highest priority powertrain operating mode.

According to an aspect of the present invention there is provided a control system for controlling a hybrid powertrain system of a vehicle. The hybrid powertrain system is operable in a plurality of powertrain operating modes each having an associated set of powertrain control parameter values. The hybrid powertrain system comprises an engine (an internal combustion engine which may be powered by petrol, diesel or hydrogen, for example) and an electric traction motor (EM). The control system comprises one or more controllers which are collectively configured to: (i) determine that the hybrid powertrain system is simultaneously operating in two or more of the plurality of powertrain operating modes; (ii) determine, based on a predetermined prioritisation index of the plurality of powertrain operating modes, which of the two or more simultaneously operating powertrain operating modes has a highest priority; and (iii) control at least one of the engine and electric traction motor via the one or more controllers based on the set of powertrain control parameter values associated with the highest priority powertrain operating mode.

The control system comprises one or more controllers collectively comprising at least one electronic processor having an electrical input for receiving an input signal; and at least one memory device electrically coupled to the at least one electronic processor and having instructions stored therein; and wherein the at least one electronic processor is configured to access the at least one memory device and execute the instructions thereon so as to perform steps (i) to (iii) above.

The control system advantageously provides a way to prioritise between sets of parameters associated with different powertrain operating modes when two or more modes are occurring simultaneously. Each powertrain operating mode has an associated set of parameters which are set to control the powertrain in a way for that operating mode. For example, one mode may require a fast response controller, and thus the parameters would be chosen so as to result in a fast response controller. Other modes may require a smooth, slower controller. The control system above uses a predetermined prioritisation index to decide on the best set of parameters for the current situation. This resolves the conflict which can occur when two or more modes are simultaneously operating, the different modes having different sets of parameters.

An advantage of the control system's ability to change control parameters is the possibility to use a single controller to control multiple situations or actuators (i.e., the EM and the engine). With different situations or operating modes (e.g., creep with engine on and connected to driveline vs creep with engine off and disconnected from driveline), the inertia of the powertrain can be very different. This can also mean that the torque to speed relationship is very different. An engine will generally produce torque in a very different way to an EM from the same request and this will change the overall response of the system. Because the control system can use different sets of parameters associated with different powertrain operating modes (which may use one or both of the EM and the engine), it is possible to use a single controller to control multiple situations or actuators.

In some embodiments, the powertrain operating modes may comprise one or more of the following:
i. A “comfort” slip start mode wherein a first clutch between the electric traction motor and the engine is partially engaged to start the engine while a second clutch between the electric traction motor and a transmission of the vehicle is also partially engaged, with the first and second clutches being fully engaged only once the engine speed is matched to the electric traction motor speed.
ii. A “response” slip start mode wherein the first clutch between the electric traction motor and the engine is partially engaged to start the engine and is fully engaged once the engine speed is matched to the electric traction motor speed, while the second clutch between the electric traction motor and the transmission remains fully engaged throughout. The “comfort” slip start mode and the “response” slip start mode are types of engine start mode in which torque from the electric traction motor is used to start the internal combustion engine. This can reduce or remove the need to use a starter motor.
iii. A guided launch mode wherein inaccuracy in the second clutch between the electric traction motor and the transmission or other torque delivery system is compensated for during vehicle acceleration from a standstill.
iv. A creep mode wherein both a brake pedal and an accelerator pedal of the vehicle are released and the vehicle creeps forwards or backwards.
v. A gear shift mode wherein a gear shift is in progress.
vi. A catalyst heating mode wherein the engine is running to increase a temperature of a catalytic converter.

Optionally, the control system may be configured to control at least one of a speed of the electric traction motor and a speed of the engine, in accordance with the set of powertrain control parameter values associated with the highest priority powertrain operating mode.

By controlling the speed of the EM and/or the engine, the control system can control whether the vehicle has a fast response or a smooth response.

Optionally, the control system may be configured to receive a target speed request; compare the target speed request to at least one of the speed of the electric traction motor or the speed of the engine; and, if a speed difference between the target speed request and the speed of the electric traction motor and/or the engine is detected; modify the speed of the electric traction motor and/or the engine, in accordance with the set of powertrain control parameter values associated with the highest priority powertrain operating mode, to reduce the speed difference.

Advantageously, this controls the speed of the controller because the modifying of the speed of the EM/engine is in accordance with the powertrain control parameter values associated with the highest priority powertrain operating mode. For example, if the priority mode requires a fast controller (e.g. a slip start mode requires a fast controller), the modification of the speed will be faster than if the priority mode requires a slow controller (e.g., a guided launch mode requires a slower controller). The powertrain control parameter values may therefore comprise a parameter prescribing how quickly the speed of the EM/engine is modified. In other words, for a fast controller, the speed of the EM/engine is changed to be closer or match the target speed much more rapidly than for a slow controller.

Optionally, each of the associated sets of powertrain control parameter values may be arranged to control a response rate at which the speed of the electric traction motor and/or the engine is modified to reduce the speed difference.

In an embodiment, the response rate of at least one of the associated sets of powertrain control parameter values is lower than the response rate of at least one other of the associated sets of powertrain control parameter values.

Optionally, the set of powertrain control parameter values may comprise one or more of: an inertia compensation parameter for speed control of the engine and/or electric traction motor, an operating temperature factor parameter (e.g., component temperatures (coolant/oil etc.) within the engine, transmission, motor, or other powertrain component), and a safety monitoring parameter.

An inertia compensation parameter can be used to convert internally from a desired speed ramp rate to a torque request (torque=moment of inertia*speed gradient). With changing system configuration, the inertia changes. Thus, for different system configurations or operating modes, the inertia compensation parameter can be chosen accordingly.

An operating temperature factor parameter can be used to accommodate or compensate for differences in the relationship between the powertrain system's response and different temperature conditions and when different actuators are used (i.e., the engine versus the EM). For example, at low temperatures, the engine may respond differently and transmission loading may be different compared to normal or higher temperatures. These relationships can be characterised differently based on the powertrain operating mode. One example of this is, when the engine is in control of idle or creep (i.e., the operating mode may be “engine creep”), a temperature factor parameter can be used to increase the torque response if the engine output drifts above or below the target value. This can compensate for higher transmission loads and slower engine response at lower temperatures.

With different conditions or operating modes, safety monitoring can apply in different ways in order to ensure the vehicle is protected from unintended acceleration. For example, during a comfort slip start, when the transmission has a decoupled clutch, it can be necessary to bound the electric machine speed control to certain values both positively and negatively in order to respect limits imposed by a safety monitoring system. These values do not necessarily apply in other vehicle operating modes such as engine creep, so can be configured to apply only in a certain situation (e.g., when the operating mode is set to comfort slip start).

Optionally, the one or more controllers may comprise a proportional integral derivative (PID) controller, and the set of powertrain control parameter values comprises a gain selection parameter comprising one or more of: a proportional gain parameter, an integral gain parameter, and a derivative gain parameter for controlling the PID controller.

This is advantageous as the different gain parameters of the PID controller finely tune the performance characteristics of the PID controller. These gain parameters can be selected to best suit the powertrain operating mode, and thus provide the best performance characteristics for that operating mode.

Optionally, the one or more controllers may collectively be configured to determine that the powertrain is simultaneously operating under two or more powertrain operating modes by: receiving data relating to one or more vehicle attributes; comparing the received data to a look-up table defining attributes of the plurality of powertrain operating modes; and determining two or more powertrain operating modes.

This is advantageous because the controller itself determines which powertrain operating modes are currently active.

Optionally, the one or more vehicle attributes may comprise one or more of: a speed of the vehicle, a speed of the engine, a speed of the electric traction motor, a target speed of the engine, a target speed of the electric traction motor, a clutch position, a gear selection, a gear change, and driver demand.

Advantageously, one or more of these vehicle attributes allow the controller to determine which powertrain operating modes are active.

Alternatively, or in addition, the one or more controllers may receive one or more signals from a separate controller indicating in which powertrain operating mode(s) the powertrain is operating. This can reduce or remove the need for the one or more controllers to determine the current powertrain operating mode(s).

According to another aspect of the invention, there is provided a system comprising the control system of any preceding statement and a hybrid powertrain system of a vehicle. The hybrid powertrain system comprising an engine and an electric traction motor.

According to yet another aspect of the invention, there is provided a vehicle comprising the system of the aspect immediately above or the control system of any statement preceding that aspect.

According to yet another aspect of the invention, there is provided a method for controlling a hybrid powertrain system of a vehicle. The hybrid powertrain system is operable in a plurality of powertrain operating modes each having an associated set of powertrain control parameter values. The hybrid powertrain system comprises an engine (an internal combustion engine which may be powered by petrol, diesel or hydrogen, for example) and an electric traction motor. The method comprises: (i) determining that the hybrid powertrain system is simultaneously operating in two or more of the plurality of powertrain operating modes; (ii) determining, based on a predetermined prioritisation index of the plurality of powertrain operating modes, which of the two or more simultaneously operating powertrain operating modes has a highest priority; and (iii) controlling at least one of the engine and electric traction motor via the one or more controllers based on the set of powertrain control parameter values associated with the highest priority powertrain operating mode.

Optionally, the method may further comprise controlling at least one of a speed of the electric traction motor and a speed of the engine, in accordance with the set of powertrain control parameter values associated with the highest priority powertrain operating mode.

Optionally, the method may further comprise receiving a target speed request; comparing the target speed request to the speed of the electric traction motor and/or the speed of the engine; and, if a speed difference between the target speed request and the speed of the electric traction motor and/or the engine is detected, modifying the speed of the electric traction motor and/or the engine, in accordance with the set of powertrain control parameter values associated with the highest priority powertrain operating mode, to reduce the speed difference.

Optionally, each of the associated sets of powertrain control parameter values may be arranged to control a response rate at which the speed of the electric traction motor and/or the engine is modified to reduce the speed difference.

According to yet another aspect of the invention, there is provided computer readable instructions which, when executed by a computer, are arranged to perform a method according to the aspect described immediately above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a block diagram illustrating a control system according to an embodiment of the present invention;

FIG. 2 shows a powertrain system according to an embodiment of the present invention;

FIG. 3A shows a schematic illustration of a vehicle according to an embodiment of the present invention;

FIG. 3B shows a schematic illustration of a rear-view of the vehicle of FIG. 3A; and

FIG. 4 shows a first flow chart showing operations performed by the control system of FIG. 1 according to an embodiment of the present invention.

### DETAILED DESCRIPTION

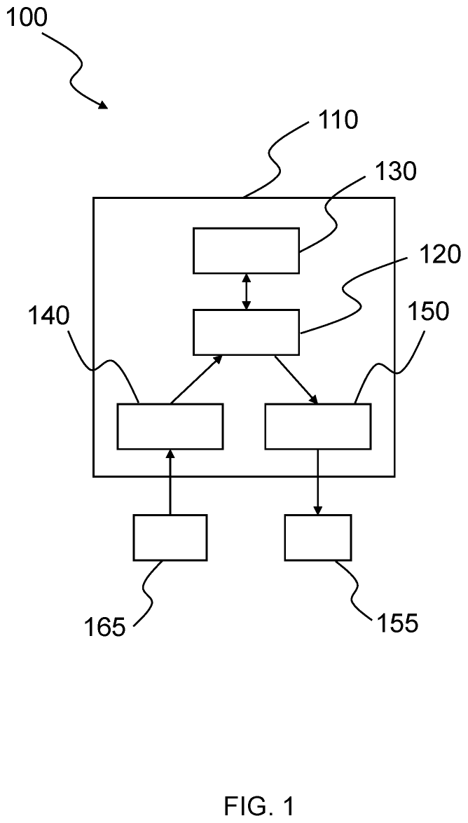

The control system 100 as illustrated in FIG. 1 comprises one controller 110, although it will be appreciated that this is merely illustrative. The controller 110 comprises processing means 120 and memory means 130. The processing means 120 may be one or more electronic processing device 120 which operably executes computer-readable instructions. The memory means 130 may be one or more memory device 130. The memory means 130 is electrically coupled to the processing means 120. The memory means 130 is configured to store instructions, and the processing means 120 is configured to access the memory means 130 and execute the instructions stored thereon.

The controller 110 comprises an input means 140 and an output means 150. The input means 140 may comprise an electrical input 140 of the controller 110. The output means 150 may comprise an electrical output of the controller 110. The input means 140 is arranged to receive one or more powertrain operating mode signals 165 from one or more sensors indicative of the currently active powertrain operating modes. For example, the one or more powertrain operating mode signals may comprise one or more vehicle attribute signals relating to one or more vehicle attributes from one or more vehicle attribute sensors. For example, the one or more vehicle attribute signals may include one or more of a vehicle speed signal relating to the speed of the vehicle from a vehicle speed sensor, an engine speed signal relating to the speed of the engine from an engine speed sensor, an electric traction motor (also referred to herein as an electric machine (EM)) speed signal relating to the speed of the EM from an EM speed sensor, a target engine speed signal relating to the target speed of the engine, a target EM speed signal relating to the target speed of the EM, a clutch position signal relating to the position of the clutch from a clutch position sensor, a gear selection signal relating to a currently selected gear from a gear selection sensor, a gear change signal relating to a currently changing gear from a gear selection sensor, and a driver demand signal relating to the driver demand from driver demand sensor. The powertrain operating mode signal 165 is an electrical signal which is indicative of powertrain operating modes that are occurring at the time. The output 150 is arranged to output a powertrain control signal 155 indicative of powertrain control parameters for controlling the powertrain, in particular, controlling at least one of the engine and the EM. For example, the powertrain control signal 155 may control at least one of a speed of the EM and a speed of the engine in accordance with the powertrain control parameters. Optionally, the powertrain signal 155 may control the rate at which the speed of the EM and/or engine is increased or decreased.

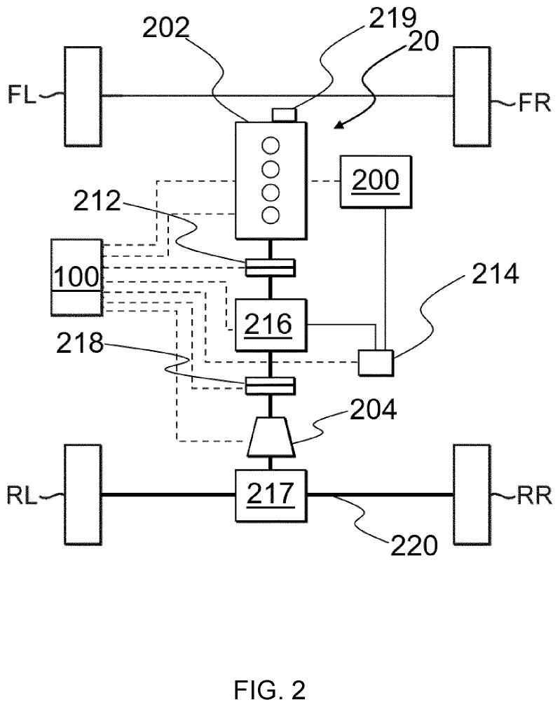

FIG. 2 illustrates an example system 20 for a parallel hybrid electric vehicle (HEV). The system 20 defines, at least in part, a powertrain of the HEV. The system 20 comprises the control system 100, as explained with reference to FIG. 1. The control system 100 may comprise one or more of: a hybrid powertrain control module; an engine control unit; a transmission control unit; a traction battery management system; and/or the like. The system 20 comprises an engine 202. The engine 202 is a combustion engine. The illustrated engine 202 is an internal combustion engine. The illustrated engine 202 comprises four combustion chambers, however a different number of combustion chambers may be provided in other examples.

The engine 202 is operably coupled to the control system 100 to enable the control system 100 to control output torque of the engine 202. The output torque of the engine 202 may be controlled by controlling one or more of: air-fuel ratio; spark timing; poppet valve lift; poppet valve timing; throttle opening position; fuel pressure; turbocharger boost pressure; and/or the like, depending on the type of engine 202.

The system 20 further comprises an electric traction motor 216. In some embodiments, the system 20 has one electric traction motor. In other embodiments, the system 20 has more than one electric traction motor. The first electric traction motor 216 may be an alternating current induction motor or a permanent magnet motor, or another type of motor. The electric traction motor is also referred to herein as an electric machine (EM). The electric traction motor 216 may be a crankshaft integrated motor generator (CIMG). The electric traction motor 216 is configured to apply positive or negative torque to the crankshaft or to an output shaft connected to the crankshaft, for example to provide functions such as: boosting output torque of the engine 202; deactivating (shutting off) the engine 202 while at a stop or coasting; activating (starting) the engine 202; and regenerative braking in a regeneration mode. In a hybrid electric vehicle mode, the engine 202 and electric traction motor 216 may both be operable to supply positive torque simultaneously to boost output torque. The electric traction motor 216 may be capable of electric only driving.

The system 20 comprises a vehicle transmission arrangement 204 for receiving output torque from the engine 202 and/or from the electric traction motor 216. The vehicle transmission arrangement 204 may comprise an automatic vehicle transmission, a semi-automatic vehicle transmission, or a manual vehicle transmission.

The engine 202 is mechanically connected or connectable to the electric traction motor 216 via a first torque path connector in the form of a first clutch 212. The electric traction motor 216 is mechanically connected or connectable to the transmission 204 via a second torque path connector in the form of a second clutch 218. The second clutch 218 is illustrated in FIG. 2 as a single clutch located along the drive shaft between the electric traction motor 216 and the transmission 204. In other embodiments, the second clutch 218 could be integrated with the electric traction motor 216 and/or with the transmission 204. In the latter example, the second clutch could be a core clutch used for gear shifts. The function of the second clutch could be provided by a single clutch, as illustrated, or a by plurality of clutches which are each configured to connect the electric traction motor 216 to the transmission 204 and thereby fulfil the function of the second clutch. For example, the second clutch could comprise a clutch which is operable to connect the electric traction motor 216 to the transmission 204 when the transmission is in one of a first set of gears (e.g., gears 1-4) and one or more further clutches which are operable to connect the electric traction motor 216 to the transmission 204 when the transmission is in one of a second set of gears (e.g. gears 5-8). The electric traction motor 216 is mechanically connected or connectable to a first set of vehicle wheels (RL, RR) via a torque path which extends from an output of the electric traction motor 216 to the second clutch 218 then to the transmission 204, then to the axle/driveshafts 220, and then to the first set of vehicle wheels (RL, RR). The engine 202 is mechanically connected or connectable to the first set of vehicle wheels (RL, RR) via a torque path which extends from an output of the engine 202, then to the first clutch 212, then to the electric traction motor 216, then to the second clutch 218, then to the transmission 204, then to the axle/driveshafts 220, and then to the first set of vehicle wheels (RL, RR). One or both of the engine 202 and the electric traction motor 216 are able to provide torque to a first axle 220 of the vehicle. However, when the torque path between the electric traction motor 216 and the first set of vehicle wheels (RL, RR) is disconnected, the torque path 220 between engine 202 and the first set of vehicle wheels (RL, RR) is also disconnected. In a vehicle overrun and/or friction braking situation, torque may flow from the first set of vehicle wheels (RL, RR) to the electric traction motor 216 and optionally to the engine 202. Torque flow towards the first set of vehicle wheels (RL, RR) is positive torque, and torque flow from the first set of vehicle wheels (RL, RR) is negative torque. The illustrated first set of vehicle wheels (RL, RR) comprises rear wheels. Therefore, the illustrated system 20 is configured for rear wheel drive. In another example, the first set of vehicle wheels may be front wheels (FL, FR). The illustrated front wheels (FL, FR) is a pair of vehicle wheels, however a different number of vehicle wheels could be provided in other examples.

The system 20 may comprise a differential 217 for receiving output torque from the transmission 204, i.e. from the gear train. The differential may be integrated into the vehicle transmission arrangement 204 as a transaxle, or provided separately.

The illustrated system 20 comprises one electric traction motor 216. In other embodiments, the system 20 may have more than one electric traction motor. The system (20) may further comprise a starter motor 219 which is mechanically connected or connectable to the engine 202. For example, the starter motor 219 may be a belt integrated starter generator (BiSG) or a pinion starter motor. In the illustration, the starter motor 219 is located at an accessory drive end of the engine 202, opposite a vehicle transmission end of the engine 202.

The control system 100 may be configured to disconnect the torque path between the engine 202 and the first set of vehicle wheels (RL, RR) in electric vehicle mode, for example to reduce parasitic pumping energy losses or to operate in an electric vehicle mode. For example, the first clutch 212 may be opened.

In some embodiments, the vehicle comprises another motive power source, or prime mover, arranged to provide torque to at least one wheel (FL, FR) of another axle of the vehicle. For example, the system (20) may further comprise a second electric traction motor (not shown) or a second internal combustion engine (not shown), either of which may provide positive torque alone or in combination with the electric traction motor 216 and/or the engine 202.

In order to store electrical power for the electric traction motor 216, the system 20 comprises a traction battery 200. The traction battery 200 provides a nominal voltage required by electrical power users such as the electric traction motor.

The traction battery 200 may be a high voltage (HV) battery. High voltage traction batteries provide nominal voltages in the hundreds of volts, as opposed to traction batteries for mild HEVs which provide nominal voltages in the tens of volts. The traction battery 200 may have a voltage and capacity to support electric only driving for sustained distances. The traction battery 200 may have a capacity of several kilowatt-hours, to maximise range. The capacity may be in the tens of kilowatt-hours, or in the hundreds of kilowatt-hours.

Although the traction battery 200 is illustrated as one entity, the function of the traction battery 200 could be implemented using a plurality of small traction batteries in different locations on the vehicle.

The system 20 may comprises one or more inverters 214. One inverter 214 is shown, for the electric traction motor 216. In other examples, two or more inverters could be provided.

It can be appreciated from the foregoing that the vehicle may be provided with motive torque from a combination of sources.

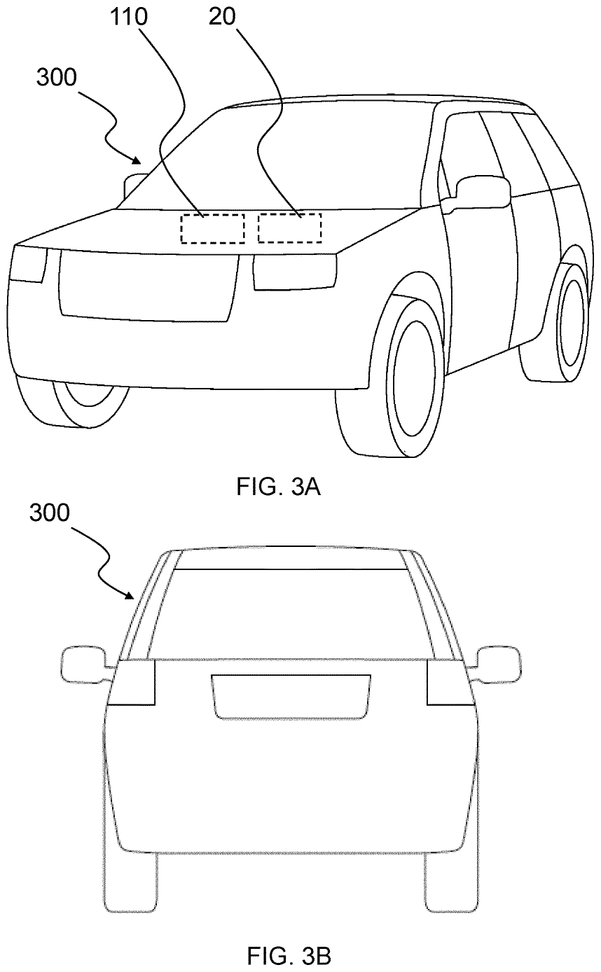

FIG. 3A illustrates a vehicle 300 according to an embodiment of the present invention. The vehicle 300 comprises a control system 100 as illustrated in FIG. 1. The controller 110 is shown as mounted within the vehicle 300 and is in communication with the powertrain 20. The powertrain 20 is a hybrid powertrain system of the vehicle 300. The powertrain 20 comprises an engine 202 and an EM 216. FIG. 3B illustrates a rear-view of the vehicle 300 of FIG. 3A.

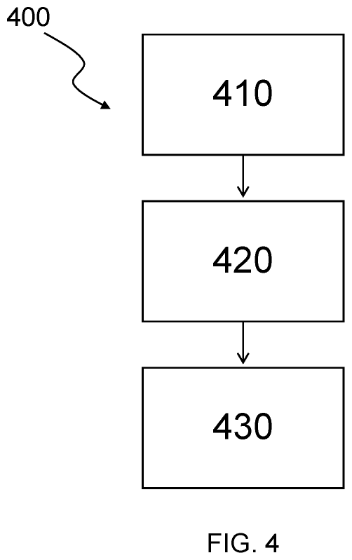

FIG. 4 illustrates a method 400 according to an embodiment of the invention. The method 400 is a method for controlling a hybrid powertrain system 20 of a vehicle 300, such as the vehicle 300 illustrated in FIGS. 3A and 3B. The hybrid powertrain system 20 is operable in a plurality of powertrain operating modes each having an associated set of powertrain control parameter values, the hybrid powertrain system comprising an engine 202 (an internal combustion engine which may be powered by petrol, diesel, hydrogen, an e-fuel, for example, or any suitable combustible fuel) and an EM 216. The method 400 may be performed by the control system 100 illustrated in FIG. 1. In particular, the memory 130 may comprise computer-readable instructions which, when executed by the processor 120, perform the method 400 according to an embodiment of the invention.

Each possible powertrain operating mode has an associated set of powertrain control parameters which may be chosen to give the best possible experience to the driver when operating in that mode, for example. As an example, these powertrain control parameters may be a compromise between minimising vehicle oscillation to provide a smooth driving experience and providing a fast vehicle response. A conflict can arise when there is more than one powertrain operating mode operating at the same time—which powertrain control parameters should be used? Method 400 determines which of the two (or more) simultaneously operating powertrain operating modes has the highest priority (based on a predetermined prioritisation index) and thus which powertrain control parameters should be used. This resolves the conflict and can provide the driver with an improved experience—whether this means minimising oscillations to provide a smooth ride or providing a fast vehicle response, or a compromise between the two (which of these is preferred will depend on which powertrain operating modes are active).

For example, the plurality of powertrain operating modes may include modes such as a comfort slip start mode, a response slip start mode, a guided launch mode, a creep mode, a gear shift mode and/or a catalyst heating mode.

A comfort slip start mode occurs when the first clutch 212 between the electric traction motor 216 and the engine 202 is partially engaged to start the engine while the second clutch 218 between the electric traction motor and the transmission 204 of the vehicle is also partially engaged, with the first and second clutches being fully engaged only once the engine speed is matched to the electric traction motor speed. This mode allows the vehicle to smoothly switch from using the electric traction motor only to using the engine either alone or in combination with the electric traction motor, by transferring torque from the electric traction motor to the engine via the first clutch to get the engine running prior to the switch. By slipping (i.e., partially engaging) the second clutch, oscillations or torque spikes which can occur due to the transfer of torque are damped, thus providing a smoother driver experience. In the following discussion, the comfort slip start mode is referred to simply as a slip start mode, since this is the normal type of slip start operation.

A response slip start mode occurs when the first clutch between the electric traction motor and the engine is partially engaged to start the engine and is fully engaged once the engine speed is matched to the electric traction motor speed, while the second clutch between the electric traction motor and the transmission remains fully engaged throughout. This differs from the comfort slip start mode above in that the second clutch is not slipped (i.e., the second clutch remains fully engaged). This mode can be used, for example, when driver demand is high, i.e., rapid acceleration is desired. This mode provides a faster vehicle response, but can mean that the ride is less smooth. In comfort slip start modes, oscillations can be less noticeable because the slipped clutch connecting the EM to the gearbox/wheels dampens the oscillations. This means the driver does not feel the oscillations as much. It can be important to have a fast controller in slip start modes because overshooting the engine/EM speed can have negative consequences on the NVH characteristics of the vehicle. Fast controllers have less overshoot than slow controllers.

In some examples, slip start modes may be further broken down into sub-modes. These modes may be distinguished based on one or more physical conditions, for example, whether positive slip or negative slip is required at the first or second clutch. Positive slip (i.e., when the engine or EM speed is greater than the road synchronisation speed) is used when it is required to transmit positive torque to the wheels. Negative slip (i.e., when the engine or EM speed is less than the road synchronisation speed) is used when it is required to transmit negative torque to the wheels. Another example of a physical condition which may be used to distinguish between different sub-modes is whether slip is increasing or decreasing and to vary the response parameters accordingly. These different sub-modes may each have their own associated set of powertrain control parameters. This is advantageous because the powertrain control parameters can be tuned for each sub-mode.

“Guided launch” is a feature in which the vehicle acceleration can be actively controlled by the vehicle when the launch clutch is open. The purpose of this feature is to optimise both the torque delivered to the wheels (to give an appropriate response to driver inputs) and the speed profile as the launch clutch, i.e. the second clutch, is closed to minimise disturbance. Whilst the controller can be controlling the same actuators or the same type of system, the desired actuator speed response can be different. For guided launch, a very smooth EM speed is desirable because this leads to smoother launch clutch closure. A “guided launch” mode occurs when inaccuracy in the second clutch between the electric traction motor and the torque delivery system is compensated for during vehicle acceleration from a standstill. The mode is used to allow the vehicle to pull away smoothly by compensating for inaccuracy in the second clutch. For the vehicle to pull away, the transmission requests a certain speed profile. As an example, if the second clutch transfers less torque to the wheels than it ideally should, the “excess torque” that is not transferred to the wheels will be transferred to the engine and/or the EM, therefore increasing the engine/EM speed. Guided launch compensates this additional engine/EM speed by setting a target speed for the engine/EM, thus, keeping the engine/EM speed consistent with the requested speed profile. In guided launch modes it is important that there are minimal oscillations to get a smooth acceleration. A slow controller is acceptable in guided launch mode.

A creep mode occurs when both a brake pedal and an accelerator pedal of the vehicle are released and the vehicle creeps forwards or backwards. Vehicle creep refers to the vehicle behaviour of automatically moving from a standstill, when the brake pedal is released with a gear selected. Automatic movement refers to movement without any driver demand. The powertrain operating mode may be determined to be in a creep mode based on the idle speed. If the vehicle speed is within a predetermined range of the idle speed, the powertrain operating mode is determined to be a creep mode. Creep modes may include one or more of EM creep, high range engine creep and low range engine creep. EM creep is used when the engine is off for both high and low range. In EM creep, the control is not as critical. EM creep is user-selectable. Low range refers to the additional gearset which can add an additional ratio increase, often offered as an off-road feature. The actuator speed is often significantly more transient in this situation due to the additional ratio, so the gains may need to be more reactive e.g., to prevent engine stall. Thus, it may be advantageous to distinguish between different creep modes and have different sets of parameters for each creep mode.

A gear shift mode occurs when a gear shift is in progress.

A catalyst heating mode occurs when the engine is running to increase a temperature of a catalytic converter.

These different modes can happen in combination, for example, guided launch mode often occurs simultaneously with creep mode, a slip start mode can occur simultaneously with creep mode or during a guided launch mode. Therefore, there needs to be a way to prioritise between the different modes because each mode has its own set of parameters. For example, is it more important to have comfort slip start's parameters or guided launch's parameters? I.e., is it more important to have a smooth response for the guided launch or a fast response for the slip start?

At step 410 of the method 400, the control system 100 is configured to determine that the hybrid powertrain system 20 is simultaneously operating in two or more of the plurality of powertrain operating modes, for example, comfort slip start mode and creep mode. The control system 100 determines which modes the hybrid powertrain system 20 is operating in from the powertrain operating mode signal 165. Optionally, this powertrain operating mode signal 165 may be produced by the controller based on receiving data relating to one or more vehicle attributes, comparing the received data to a look-up table defining attributes of the plurality of powertrain operating modes, and based on this, determining two or more powertrain operating modes. As discussed above, the one or more vehicle attributes may include one or more of: a speed of the vehicle, a speed of the engine, a speed of the EM, a target speed of the engine, a target speed of the EM, a clutch position, a gear selection, a gear change, and driver demand.

At step 420, the control system 100 is configured to determine, based on a predetermined prioritisation index of the plurality of powertrain operating modes, which of the two or more simultaneously operating powertrain operating modes has a highest priority.

For example, a plurality of powertrain operating modes may each be given a numeric code (this is one example for illustrative purposes, it will be appreciated that there are many ways in which the different powertrain operating modes may be encoded):

| Mode | Situation |
|---|---|
| 1 | EM creep |
| 2 | High range engine creep |
| 3 | Low range creep |
| 4 | EM guided launch |
| 5 | Engine guided launch |
| 6 | Comfort slip start |
| 7 | Response slip start |
| 8 | Catalyst heating |
| 9 | Gear shift in progress |

Then, each code is associated with a priority (with 1 being the highest priority and 4 being the lowest):

| Priority | Modes |
|---|---|
| 1 | 9 |
| 2 | 6, 7 |
| 3 | 4, 5 |
| 4 | 8 |
| 5 | 1, 2, 3 |

Therefore, in this example, the gear shift in progress mode always has the highest priority, no matter which other powertrain operating mode simultaneously occurs. This gear shift in progress mode is specifically used for slip starts which occur at the same time as the speed change phase of a gear shift. During a gear shift, the speed of the actuator (the EM) changes very quickly which causes oscillations for the driver. Therefore, it is a high priority for the controller to remedy this to minimise the oscillations, thus improving the driver's experience.

Priority 2 contains the slip start (SS) modes. The powertrain is either in comfort slip start mode or response slip start mode. Thus, there is no problem with both of these modes having the same priority as it is not possible for these two SS modes to occur simultaneously. Priority 3 contains the guided launch modes. The powertrain is either in EM guided launch mode (i.e., the EM is in use for the guided launch) or engine guided launch mode (i.e., the engine is used for the guided launch). Thus, there is no problem with both of these modes having the same priority as it is not possible for these two guided launch modes to occur simultaneously. Priority 4 contains the catalyst heating mode. Priority 5 contains the creep modes. EM creep, high range engine creep and low range engine creep are all mutually exclusive so there is no problem with these modes having the same priority as it is not possible for these modes to occur simultaneously. The creep mode either uses the EM, the engine, or is using low range gear. In the catalyst heating mode, the engine combustion settings are operated in a different mode designed to increase the heat in the exhaust to expedite how quickly the catalyst warms up. This includes increased engine speed, different injection types, late spark triggering late combustion in the cycle etc. The focus is on heating the catalyst, not the engine.

It will be appreciated that these modes are only exemplary. Other operating modes may also be envisaged. For example, a specific combination of operating modes may in itself be considered a further operating mode with an associated set of powertrain control parameter values. For example, a further operating mode may be “Slip start with gear shift” having its own set of powertrain control parameter values which are distinguished from the sets of powertrain control parameter values for slip start mode (comfort or response) and gear shift in progress.

At step 430, the control system 100 is configured to control at least one of the engine and the EM via the one or more controllers 110 based on the set of powertrain control parameter values associated with the highest priority powertrain operating mode. Optionally, the controlling of the engine/EM may involve the control system 100 controlling a speed of the EM and/or a speed of the engine, in accordance with the set of powertrain control parameter values associated with the highest priority powertrain operating mode. Optionally, controlling the speed may involve the control system 100 being configured to receive a target speed request (which may be an EM target speed request or an engine speed request). The control system 100 then compares the target speed request to the EM speed or engine speed, depending on the type of target speed request (EM or engine). If a speed difference between the target speed request and the speed of the EM/engine is detected, the speed of the EM/engine is modified in accordance with the set of powertrain control parameter values associated with the highest priority powertrain operating mode, in order to reduce the speed difference (i.e., change the engine/EM speed to be closer to or at the target speed). Optionally, each of the associated sets of powertrain control parameter values may be arranged to control a response rate at which the speed of the EM and/or the engine is modified to reduce the speed difference. The response rates prescribed by the associated sets of powertrain control parameter values vary between the different sets, i.e., the response rate of at least one of the associated sets of powertrain control parameter values is lower than the response rate of at least one other of the associated sets of powertrain control parameter values. By controlling the response rate of the EM and/or the engine, the control system 100 can control whether the vehicle has a fast response or a smooth response. I.e., when the driver demands acceleration, for example, does the vehicle respond quickly or slowly? Responding slowly provides a smoother response. Responding quickly provides a jerkier response. For example, in general, slip start modes require a fast response (with response slip start mode requiring a particularly fast response), whereas creep modes and guided launch modes require smooth responses to avoid perceptible oscillations.

The sets of powertrain control parameter values may include values relating to one or more of inertia compensation for speed control of the engine/EM, operating temperatures (e.g., EM battery temperature), the state of charge of the EM battery, and safety monitoring. For example, safety monitoring may include L2 (level 2) constraints. Level 2 constraints refer to the safety monitoring partition of the control module. Level 1 refers to the main section of code which makes decisions and is responsible for the control, and the level 2 checks that this software makes safe decisions.

The one or more controllers 110 may comprise a proportional integral derivative (PID) controller. The sets of powertrain control parameter values change the PID controller tuning to result in different performance characteristics. The PID controller is tuned using gain selection parameters. The powertrain control parameter values which change the tuning of the PID controller may comprise one or more of a proportional gain parameter, an integral gain parameter, and a derivative gain parameter. These parameters may be defined as follows:

$$\begin{matrix}Proportional gain = ( Target speed - Actual speed ) * Kp \\ Integral gain = [ Sum over time of ( Target speed - Actual speed ) ] * KI \\ Derivative Gain = [ Gradient of ( Target speed - Actual speed ) ] * Kd \\ {K}_{p} = proportional gain parameter coefficient \\ KI = integral gain parameter coefficient \\ Kd = derivative gain parameter coefficient\end{matrix}$$

The (Target speed−Actual speed) can be thought of an error value.

Thus, the sets of powertrain control parameter values may comprise any one of a proportional gain parameter, an integral gain parameter, a derivative gain parameter, a proportional gain parameter coefficient, an integral gain parameter coefficient, and a derivative gain parameter coefficient.

For example, as described above, a distinction is made between acceleration and deceleration slip start phases because during acceleration, the controller tends to overshoot, whereas for deceleration it tends to undershoot. Therefore, the gain tuning is set differently (via the set of powertrain control parameters).

There may be at least two controllers in the control system 100, one controller to control the engine (“engine controller”) and one controller to control the EM (“EM controller”). Most of the time, only one controller is needed because when the clutch connecting the engine to the EM is closed, the EM speed and the engine speed are the same. Usually, it is the EM controller which takes over and controls both the EM and the engine. This is because using the EM controller is generally more accurate than using the engine controller. There can also be efficiency benefits to using the EM for control, for example because less torque reserve is required from the engine. When the clutch between the engine and the EM is closed, whichever speed the EM is operating at, the engine will match. The EM and the engine speed can only differ when the clutch between them is open. In this case, both the engine controller and the EM controller are needed as they are controlling different speeds (the engine speed and the EM speed). The engine controller and the EM controller are only both active during a slip start mode. During a slip start mode, the engine is started and the engine speed is increased to match the EM speed, at which point the clutch between the engine and the EM will be closed and the EM controller will take over the engine controller. The control system 100 may comprise a powertrain control module configured to control operation of both the engine and the electric traction motor. The control system 100 may comprise a transmission control module configured to control operation of the transmission and optionally of the second clutch.

In summary, embodiments of the invention provide a way to balance the trade-off of a fast controller, which provides a fast response but can increase oscillations to the possible detriment of NVH characteristics, with a slow controller, which provides a slower response but with fewer oscillations. In some scenarios, it is better to have a fast controller because either the oscillations are damped (e.g., in slip start the clutch between the EM and the gearbox/wheels is slipped) or the oscillations are not important relative to the required speed of response. Embodiments of the invention provide a way to handle many different scenarios (different combinations of operating modes) to provide the best possible type of control for any given scenario.

It will be appreciated that various changes and modifications can be made to the present invention without departing from the scope of the present application.

For purposes of this disclosure, it is to be understood that reference to ‘the control system being configured to’ is to be understood to mean ‘the one or more controllers of the control system are collectively configured to’. The controller(s) described herein can each comprise a control unit or computational device having one or more electronic processors, the one or more processors collectively configured to perform the control system functionality set out in the control system claims.

1. A control system for controlling a hybrid powertrain system of a vehicle, the hybrid powertrain system being operable in a plurality of powertrain operating modes each having an associated set of powertrain control parameter values, the hybrid powertrain system comprising an engine and an electric traction motor, the control system comprising one or more controllers collectively configured to:
determine that the hybrid powertrain system is simultaneously operating in two or more of the plurality of powertrain operating modes;
determine, based on a predetermined prioritisation index of the plurality of powertrain operating modes, which of the two or more simultaneously operating powertrain operating modes has a highest priority; and
control at least one of the engine and electric traction motor via the one or more controllers based on the set of powertrain control parameter values associated with the highest priority powertrain operating mode.

2. The control system of claim 1, wherein the control system is configured to control at least one of a speed of the electric traction motor and a speed of the engine, in accordance with the set of powertrain control parameter values associated with the highest priority powertrain operating mode.

3. The control system of claim 2, wherein the control system is configured to:
receive a target speed request;
compare the target speed request to at least one of the speed of the electric traction motor or the speed of the engine; and, if a speed difference between the target speed request and the speed of the electric traction motor and/or the engine is detected;
modify the speed of the electric traction motor and/or the engine, in accordance with the set of powertrain control parameter values associated with the highest priority powertrain operating mode, to reduce the speed difference.

4. The control system of claim 3, wherein each of the associated sets of powertrain control parameter values is arranged to control a response rate at which the speed of the electric traction motor and/or the engine is modified to reduce the speed difference.

5. The control system of claim 1, wherein the set of powertrain control parameter values comprise one or more of: an inertia compensation parameter for speed control of the engine and/or electric traction motor, an operating temperature factor parameter, a safety monitoring parameter.

6. The control system of claim 1, wherein the one or more controllers comprise a proportional integral derivative (PID), controller, and the set of powertrain control parameter values comprises a gain selection parameter comprising one or more of: a proportional gain parameter, an integral gain parameter, and a derivative gain parameter for controlling the PID controller.

7. The control system of claim 1, wherein the one or more controllers determine the powertrain is simultaneously operating under two or more powertrain operating modes by:
receiving data relating to one or more vehicle attributes;
comparing the received data to a look-up table defining attributes of the plurality of powertrain operating modes; and
determining two or more powertrain operating modes.

8. The control system of claim 7, wherein the one or more vehicle attributes comprise one or more of: a speed of the vehicle, a speed of the engine, a speed of the electric traction motor, a target speed of the engine, a target speed of the electric traction motor, a clutch position, a gear selection, a gear change, and driver demand.

9. A system comprising the control system of claim 1 and a hybrid powertrain system of a vehicle, the hybrid powertrain system comprising an engine and an electric traction motor.

10. A vehicle comprising the control system of claim 1.

11. A method for controlling a hybrid powertrain system of a vehicle, the hybrid powertrain system being operable in a plurality of powertrain operating modes each having an associated set of powertrain control parameter values, the hybrid powertrain system comprising an engine and an electric traction motor, the method comprising:
determining that the hybrid powertrain system is simultaneously operating in two or more of the plurality of powertrain operating modes;
determining, based on a predetermined prioritisation index of the plurality of powertrain operating modes, which of the two or more simultaneously operating powertrain operating modes has a highest priority; and
controlling at least one of the engine and electric traction motor via the one or more controllers based on the set of powertrain control parameter values associated with the highest priority powertrain operating mode.

12. The method of claim 11, further comprising controlling at least one of a speed of the electric traction motor and a speed of the engine, in accordance with the set of powertrain control parameter values associated with the highest priority powertrain operating mode.

13. The method of claim 12, further comprising:
receiving a target speed request;
comparing the target speed request to the speed of the electric traction motor and/or the speed of the engine; and, if a speed difference between the target speed request and the speed of the electric traction motor and/or the engine is detected,
modifying the speed of the electric traction motor and/or the engine, in accordance with the set of powertrain control parameter values associated with the highest priority powertrain operating mode, to reduce the speed difference.

14. The method of claim 13, wherein each of the associated sets of powertrain control parameter values are arranged to control a response rate at which the speed of the electric traction motor and/or the engine is modified to reduce the speed difference.

15. Computer readable instructions which, when executed by a computer, are arranged to perform the method according to claim 11.
